(19) United States
(12) Patent Application Publication
(10) Pub. No.: US 2016/0320479 A1
(43) Pub. Date: Nov. 3, 2016

(54) METHOD FOR EXTRACTING GROUND ATTRIBUTE PERMANENT SCATTER IN INTERFEROMETRY SYNTHETIC APERTURE RADAR DATA

(71) Applicant: Tianjin Institute of Surveying and Mapping, Tianjin (CN)

(72) Inventors: Huashan Ma, Tianjin (CN); Junwei Liu, Tianjin (CN); Ke Hu, Tianjin (CN); Jie Wang, Tianjin (CN); Tie Sun, Tianjin (CN); Kui Yang, Tianjin (CN); Chu Chen, Tianjin (CN); Zhengpeng Wu, Tianjin (CN); Yongqing Hu, Tianjin (CN)

(73) Assignee: Tianjin Institute of Surveying and Mapping

(21) Appl. No.: 15/051,674

(22) Filed: Feb. 24, 2016

(30) Foreign Application Priority Data
Apr. 29, 2015 (CN) 201510214592.1

(51) Int. Cl. G01S 13/90

(52) U.S. Cl. CPC G01S 13/9023

(57) ABSTRACT

The invention relates to a method for extracting ground attribute data in interferometry synthetic aperture radar data, and aims at providing a method for extracting ground attribute data in PS data. The method comprises the following steps that ground geographic data are led; ground boundary data are contracted inwards by Tₓ in the east-west direction, and are contracted inwards by T_{y} in the south-north direction, and a new ground boundary is determined again; whether each PS point falls into the new ground boundary or not is judged, and if yes, the data are extracted; if not, the data are removed; a first data set after extraction is obtained; whether the gray value of a PS point image in the first data set is between Vₘᵢₙ and Vₘₐₓ or not is judged, and if yes, the data are further extracted; if not, the data are removed. The ground attribute data are extracted through the method, so that the accuracy of PS points is 95.1 percent.

### CROSS-REFERENCE TO RELATED APPLICATIONS

This application claims priority to, Chinese Patent Application No. 201510214592.1 with a filing date of Apr. 29, 2015. The content of the aforementioned application, including any intervening amendments thereto, is incorporated herein by reference.

### TECHNICAL FIELD

The invention relates to technology of synthetic aperture radar, more particularly, to a method for extracting ground attribute data in interferometry synthetic aperture radar data.

### BACKGROUND OF THE PRESENT INVENTION

Synthetic Aperture Radar (SAR), an important earth monitoring method of remote sensing, can produce high-resolution microwave image by means of the principle of synthetic aperture, which is widely recognized and used in disaster monitoring, environment monitoring, surveying and other fields.

Interferometry Synthetic Aperture Radar (InSAR), an important branch of SAR, is the most widely used. The basic principle is to utilize the SAR images in the same area to find the Permanent Scatter (PS) which is, not affected by time and space baseline decorrelation and changing atmosphere, by statistical analysis about the returned phase and amplitude information. A triangle network is made based on these points and differential interferograms, and the accurate deformation value is obtained by utilizing the phase difference of adjacent points in different images and adopting certain deformation inversion model for time-space phase unwrapping. (FIG. 1)

InSAR can monitor PS point targets which are ground objects capable of strong and stable scattering properties to radar wave in long time series. In SAR images, PS is the image pixel corresponding to the ground PS targets, the phase information of high-signal noise ratio recorded by these pixels are less affected by time decorrelation and space decorrelation and can keep high interferometric coherence on long-time series; meanwhile, PS targets have high reflectivity on radar wave, so it has high brightness in SAR image intensity graph. These PS points are various complicated ground objects on the earth surface, such as buildings, ground, bridges, pipelines and the like. In common InSAR application, these ground objects are not distinguished to be analyzed, so problems like insufficient pertinence and accuracy of ground subsidence calamity analysis exist.

Through analysis about subsidence targets, there is a distinct difference in infrastructure covered by different ground objects, and the characteristic of ground subsidence is affected by various factors. Through deformation analysis about large-scale regional ground, it can be considered that deformation degree of pixel point represents the actual deformation of ground, however, this assumption is not reasonable for those cities with dense buildings and engineering facilities. Taking buildings as an example, the pile foundation of buildings differ in a thousand ways, especially for the high-rise buildings which contains the step to consolidate pile foundation in foundation treatment, and the origin force of pile foundation is deep in the ground. The subsidence phenomenon caused by the self gravity of buildings reflect the interaction result between buildings and deep formation through pile foundation, buildings have no direct relation with support of earth surface and are actual different with the ground subsidence, the subsidence of earth surface is different in time and speed with that of buildings. So through analysis about subsidence targets, it is necessary to distinguish buildings, ground and other different kinds of permanent scattering points.

The ground subsidence can be divided into types of natural factor and human factor based on the causes from analysis about subsidence mechanism. Types of natural factor are mainly subsidence caused by geological conformation movement, consolidation of soft soils and the like; Types of human factor are mainly subsidence caused by excessive extraction of underground water, engineering construction and the like. Besides, the characteristics of two types are different. The former one has wholeness, the corresponding monitoring information has characteristics of slow variation, small gradient etc, in a certain range and interpolation, while the latter one has locality, the corresponding monitoring information has characteristics of large variation gradient, limited influence range etc. compared with the surrounding ground objects. So the subsidence mechanism of different types of ground objects targets are different from analysis about theory of subsidence mechanism, and the characteristics of subsidence information are also different, so that the attribute classification of PS points should be carried out.

### SUMMARY OF THE PRESENT INVENTION

The purpose of the present invention is to realize the extraction of ground attribute data in PS data by providing a method for extracting ground PS point based on the geographic information database and image feature.

The method for extracting ground attribute data in interferometry synthetic aperture radar data comprises the following steps

1. Ground Point Extraction Based on Geographic Database

Ground geographic data are led, including at least the longitude and latitude of ground boundary;

Due to geocoding error of PS points, and the error discrepancy of distinct ground objects in different directions, set the location error of ground PS point in the east-west direction and in the south-north direction after geocoding error as Tₓ and T_{y} respectively. So ground boundary data are contracted inwards by Tₓ in the east-west direction, and are contracted inwards by T_{y} in the south-north direction according to the geocoding error of ground PS point, so that a new ground boundary is determined again (FIG. 2).

InSAR monitoring results are expressed in the form of results of scattering PS points, and ground data is expressed in the form of surface. The attributive classification based on geographic database is to determine the topological relation of PS points and basic geographic data surface, mainly by overlay analysis. Actually, the overlay of point and polygon is to calculate the inclusion relation of polygon to the point. Geographic Information System(GIS) with vector structure can judge whether the PS point falls into the ground polygon after buffering or not, by calculating the position of each PS point against the line of ground polygon (FIG. 3); if the PS point falls into the new ground boundary after buffering, this PS point is extracted as the ground PS point, if the PS point falls out of the new ground boundary, this PS point is removed; all the monitoring results about PS points are analyzed through the method, so that a first data set after extraction is obtained.

2. Ground Point Extraction Based on Image Feature Database

Ground PS points are distinct alternately bright and dark on SAR image. By theoretical analysis, ground is made up of the same types of points, and the location distribution of these points are random, so the phase of electromagnetic wave, the echo initial phase, and the echo amplitude received by each point is different, but no echo scattering of each point can play a dominate role in total echo power. After the radar beam scanned over these points, the received electromagnetic wave signal by radar antenna will form periodic signal, which creates the periodic variation of this kind of ground objects from strongest signal to weakest signal, and causes pattern spot with alternately bright spot and dark spot, so that the “spot size” effect is formed. So the extraction of ground points based on image feature library is carried out based on the image features of ground PS points.

The method is to extract the gray value of each SAR image of the corresponding pixel in time series of PS points in the first data set (gray value is the gray degree of images, the value range is 0˜255, which represents the brightness from high to low, corresponding to color in images from black to white), then the mean value is calculated; the relation of acceptable interval [Vₘᵢₙ, Vₘₐₓ] between the mean gray value and ground gray value is judged to classify; if the value is within the interval, the data are further extracted, otherwise, the data are removed; of which Vₘᵢₙ is the minimum gray value of ground, attribute PS points, and Vₘₐₓ is the maximum gray value of ground attribute PS points.

A second data set after extraction is further obtained, the attribute of the PS points in this data set, are the ground, which is the finally extracted ground PS points set.

Compared with the prior art, the present invention has following advantages:

1. The ground attribute data are extracted after sequential InSAR processing through the method, so that the accuracy of PS points is 95.1 percent.

2. The accuracy of ground subsidence monitoring results after the attribute data are extracted is 5 mm superior to that of leveling surveying.

### BRIEF DESCRIPTION OF THE DRAWINGS

FIG. 1 is the schematic diagram of InSAR, the upper three drawings are multiple images obtained at different times, the lower two drawings are analysis of time series about the selected PS point.

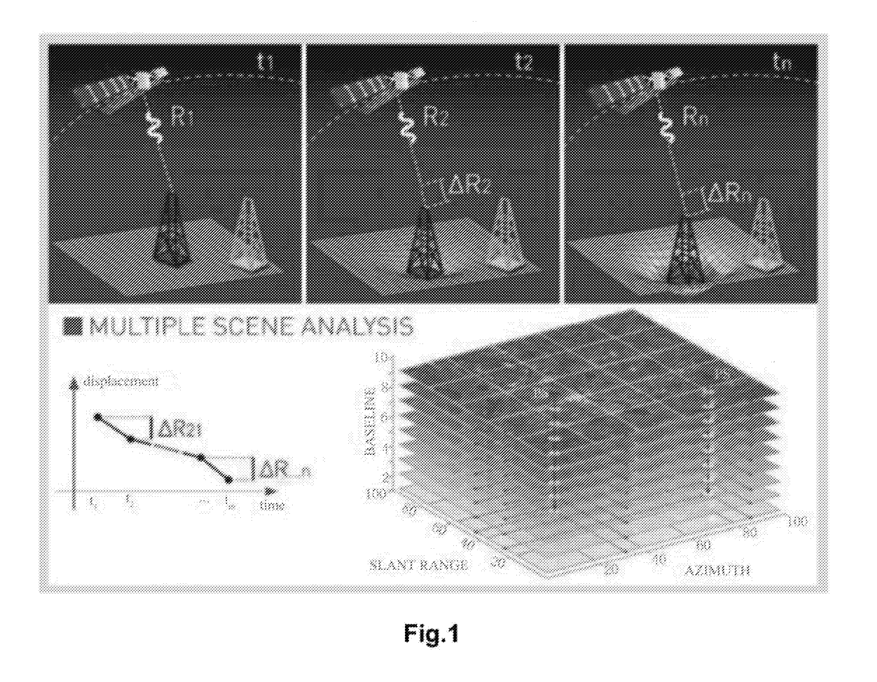

FIG. 2 is the contracted inwards diagram in the east-west direction and the south-north direction of the present invention, in which the outer rectangle is the determined ground boundary by geographic data, and the inner rectangle is the determined ground boundary after inward contracting.

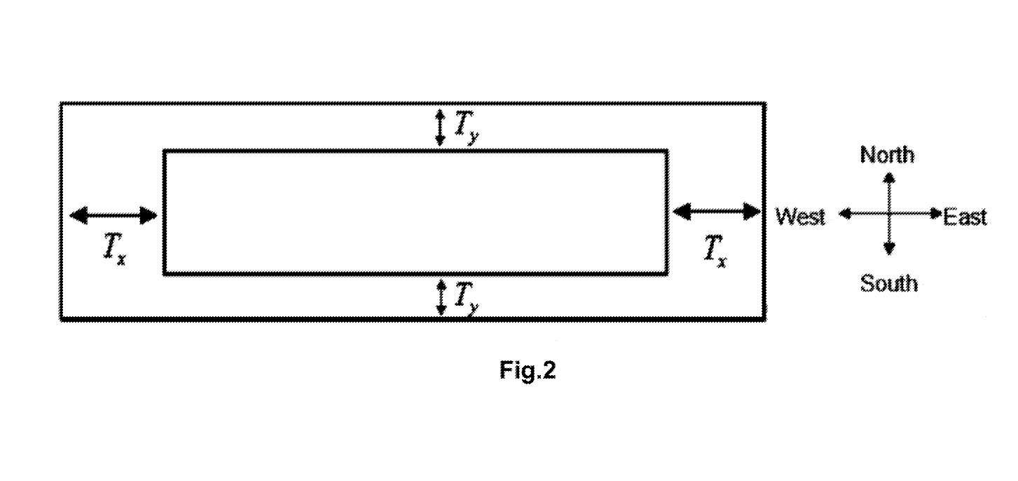

FIG. 3 is the analysis diagram about topological relation between PS points and ground space, which is judged by space overlaying analysis about scattering PS points and surface ground data under the same geography space frame

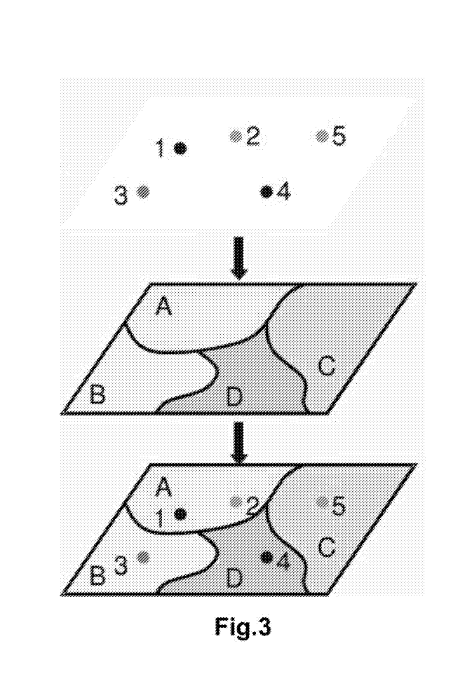

### DETAILED DESCRIPTION OF PREFERRED EMBODIMENTS

### Embodiments

Analysis About Geocoding Error

ground points in the experimental area are chose to analyze the geocoding error, the error statistics is as Table One shown. The mean square error of X direction (east-west direction) is 1.19 m, the mean square error of Y direction (south-north direction) is 0.94 m, and the total mean square error in plane is 1.52 m.

2. Two-Dimensional Space Analysis Based on Geographic Database.

Ground in the experimental area is to explain the process of data extraction as an example.

The cover area is 1.3 square kilometers, and the total PS points are 2931 after sequential InSAR data processing.

At first, ground geographic data are led, including at least the longitude and latitude of ground boundary;

Boundary data are contracted inwards by 1.19 m in the east-west direction and are contracted inwards by 0.94 m in the south-north direction, and a new ground boundary is determined again.

Whether 2931 PS points fall into the new ground boundary or not is, judged, and if, yes, the data are extracted; if not, the data are removed;

A first dataset after extraction is obtained, including 1285 PS points; the abnormal points are 206 after analysis and the accuracy is 83.7%.

3. Analysis About in Age Features Based on Image Feature Database

100 ground PS points in 14 experimental areas are chose to analyze the ground gray information, the information is as Table Two shown, of which the mean value μ is 106.1, and the mean square error δ is 26.6. Based on the statistical theory of error probability distribution, the gray acceptable interval of ground PS point is [μ . . . 2δ, μ+2δ], and the corresponding interval is [53, 159] because the gray value is integer.

Whether the gray value of a PS point image in the first data set is between 53 and 159 or not is judged, and if yes, the data are further extracted: if not, the data are removed;

A second data set after extraction is further obtained, the attribute of the PS points in this data set is the ground. 1075 PS points with high credibility are obtained finally, and the abnormal points are 53 after analysis, the accuracy is 95.1%.

The monitoring density is 826 per square kilometers, the maximum subsidence point is −14.76 mm/yr and the average subsidence volume is −5.77 mm/yr.

TABLE 1
Error Analysis about Geocoding of Ground Points

| No | InSAR_X | InSAR_Y | GCP_X | GCP_Y | dx | dy |
|---|---|---|---|---|---|---|
| 1 | 141825.66 | 285283.88 | 141824.56 | 285284.8638 | 1.10 | −0.98 |
| 2 | 141680.20 | 284635.45 | 141680.17 | 284634.2978 | 0.03 | 1.16 |
| 3 | 142326.89 | 284810.62 | 142326.53 | 284811.3343 | 0.36 | −0.71 |
| 4 | 141306.14 | 285282.01 | 141305.26 | 285281.0458 | 0.89 | 0.96 |
| 5 | 142948.60 | 285089.38 | 142948.05 | 285088.6009 | 0.55 | 0.78 |
| 6 | 143579.62 | 285769.78 | 143578.99 | 285770.4259 | 0.63 | −0.65 |
| 7 | 143883.68 | 285426.99 | 143882.79 | 285427.1965 | 0.89 | −0.20 |
| 8 | 142260.31 | 284121.51 | 142261.19 | 284120.9835 | −0.88 | 0.52 |
| 9 | 141959.80 | 284112.65 | 141961.39 | 284112.2042 | −1.59 | 0.45 |
| 10 | 141759.70 | 282279.89 | 141760.61 | 282278.213 | −0.90 | 1.68 |
| 11 | 141918.86 | 281340.69 | 141917.59 | 281341.6432 | 1.28 | −0.95 |
| 12 | 143453.57 | 282094.66 | 143453.01 | 282095.2933 | 0.56 | −0.63 |
| 13 | 144492.34 | 284237.73 | 144493.57 | 284238.26 | −1.22 | −0.54 |
| 14 | 144915.82 | 284589.45 | 144914.09 | 284590.05 | 1.73 | −0.61 |
| 15 | 145030.94 | 284421.13 | 145029.22 | 284420.89 | 1.72 | 0.24 |
| 16 | 144967.24 | 283936.09 | 144967.86 | 283935.37 | −0.62 | 0.72 |
| 17 | 145867.18 | 283228.88 | 145864.56 | 283226.75 | 2.62 | 2.13 |
| 18 | 146540.98 | 283741.61 | 146540.98 | 283742.09 | 0.00 | −0.47 |
| 19 | 146424.90 | 283028.60 | 146426.53 | 283028.32 | −1.63 | 0.28 |
| 20 | 148425.46 | 282882.72 | 148424.18 | 282882.97 | 1.29 | −0.25 |
| 21 | 148475.11 | 283086.69 | 148474.82 | 283087.91 | 0.29 | −1.22 |
| 22 | 144435.61 | 286397.67 | 144436.90 | 286396.80 | −1.29 | 0.86 |
| 23 | 148725.11 | 285271.97 | 148726.11 | 285273.76 | −1.00 | −1.79 |
| 24 | 147020.34 | 285098.09 | 147019.18 | 285099.78 | 1.16 | −1.69 |
| 25 | 147187.60 | 285620.43 | 147188.07 | 285620.09 | −0.48 | 0.33 |
| 26 | 146288.99 | 286535.71 | 146287.28 | 286535.61 | 1.70 | 0.10 |
| 27 | 146959.38 | 286427.22 | 146957.96 | 286426.77 | 1.42 | 0.45 |
| | Mean | 1.19 | Mean | 0.94 | Total | 1.52 |
| | square | | square | | Mean | |
| | error | | error | | square | |
| | in X | | in Y | | error | |
| | direction | | direction | | | |

In the table, InSAR_X represents the location of X direction (east-west direction) of InSAR data, and InSAR_Y represents the location of Y direction (south-north direction) of InSAR data, GCP-X represents the location of X direction (east-west direction) of practical measured data, and GCP-X represents the location of Y direction (east-west direction) of practical measured data, dx represents the error of X direction (east-west direction), and dy represents the error of Y direction (south-north direction).

TABLE 2
Analysis about Gray Value of Ground Points

| | Gray |
|---|---|
| NO. | Value |
| 1 | 53 |
| 2 | 68 |
| 3 | 45 |
| 4 | 41 |
| 5 | 58 |
| 6 | 92 |
| 7 | 74 |
| 8 | 68 |
| 9 | 56 |
| 10 | 44 |
| 11 | 63 |
| 12 | 50 |
| 13 | 65 |
| 14 | 63 |
| 15 | 89 |
| 16 | 85 |
| 17 | 89 |
| 18 | 86 |
| 19 | 98 |
| 20 | 120 |
| 21 | 108 |
| 22 | 110 |
| 23 | 96 |
| 24 | 88 |
| 25 | 98 |
| 26 | 92 |
| 27 | 101 |
| 28 | 101 |
| 29 | 116 |
| 30 | 91 |
| 31 | 123 |
| 32 | 122 |
| 33 | 127 |
| 34 | 139 |
| 35 | 133 |
| 36 | 133 |
| 37 | 127 |
| 38 | 122 |
| 39 | 123 |
| 40 | 125 |
| 41 | 128 |
| 42 | 129 |
| 43 | 103 |
| 44 | 88 |
| 45 | 106 |
| 46 | 104 |
| 47 | 113 |
| 48 | 130 |
| 49 | 121 |
| 50 | 122 |
| 51 | 112 |
| 52 | 105 |
| 53 | 111 |
| 54 | 109 |
| 55 | 115 |
| 56 | 115 |
| 57 | 83 |
| 58 | 83 |
| 59 | 81 |
| 60 | 78 |
| 61 | 90 |
| 62 | 116 |
| 63 | 102 |
| 64 | 105 |
| 65 | 89 |
| 66 | 80 |
| 67 | 92 |
| 68 | 84 |
| 69 | 95 |
| 70 | 94 |
| 71 | 122 |
| 72 | 83 |
| 73 | 122 |
| 74 | 121 |
| 75 | 125 |
| 76 | 133 |
| 77 | 129 |
| 78 | 128 |
| 79 | 124 |
| 80 | 121 |
| 81 | 119 |
| 82 | 123 |
| 83 | 124 |
| 84 | 126 |
| 85 | 132 |
| 86 | 98 |
| 87 | 140 |
| 88 | 140 |
| 89 | 141 |
| 90 | 147 |
| 91 | 147 |
| 92 | 145 |
| 93 | 147 |
| 94 | 146 |
| 95 | 138 |
| 96 | 147 |
| 97 | 144 |
| 98 | 147 |
| 99 | 92 |
| 100 | 94 |

Statistics
Mean square error: 106.1
Root mean square error: 26.6

We claim:

1. A method for extracting ground attribute data in interferometry synthetic aperture radar data, characterized in that
Ground geographic data are led, including at least the longitude and latitude of ground boundary;
Ground boundary data are contracted inwards by Tₓ in the east-west direction, and are contracted inwards, by T_{y} in the south-north direction, and a new ground boundary is determined again; wherein the Tₓ is the location error of InSAR in the east-west direction and T_{y} is the location error of InSAR in the south-north direction.
Whether each PS point falls into the new ground boundary or not is judged, and if yes, the data are extracted; if not, the data are removed; a first data set after extraction is obtained;
Whether a gray value of a PS point image in the first data set is between Vₘᵢₙ and Vₘₐₓ or not is judged, and if yes, the data are further extracted; if not, the data are removed; Vₘᵢₙ is the minimum gray value of ground attribute PS point, and Vₘₐₓ is the maximum gray value of ground PS point.
A second data set after extraction is further obtained, the attribute of the PS points in this data set is the ground.

2. The method for extracting ground attribute data in interferometry synthetic aperture radar data according to claim 1, characterized in that Tₓ=1.19; T_{y}=0.94; Vₘᵢₙ=53; and Vₘₐₓ=160.
